(19) United States
(12) Patent Application Publication
(10) Pub. No.: US 2024/0399359 A1
(43) Pub. Date: Dec. 5, 2024

(54) NUCLEIC ACID AMPLIFICATION TESTING DEVICES AND METHODS

(71) Applicant: TOKITAE LLC, Bellevue, WA (US)

(72) Inventors: John CONNELLY, Seattle, WA (US); Bernhard WEIGL, Seattle, WA (US); Daniel LIEBERMAN, Issaquah, WA (US); Matthew KELLER, Kirkland, WA (US); Joshua BISHOP, Seattle, WA (US); Ryan CALDERON, Seattle, WA (US); Chin Hei NG, Newcastle, WA (US); Rob JENISON, Seattle, WA (US); Paul DAVIS, Northamptonshire (GB); Lucy BEALES, York (GB); Kevin LAND, Bedford (GB); Ben SULLIVAN, Seattle, WA (US)

(73) Assignee: TOKITAE LLC, Bellevue, WA (US)

(21) Appl. No.: 18/679,261

(22) Filed: May 30, 2024

Related U.S. Application Data
(60) Provisional application No. 63/504,918, filed on May 30, 2023.

(51) Int. Cl. B01L 3/00; B01L 7/00

(52) U.S. Cl. CPC B01L 3/5023; B01L 7/52; B01L 2200/0684; B01L 2200/0689; B01L 2300/048; B01L 2300/0825

(57) ABSTRACT

Methods, apparatuses, and testing devices comprising a fluid management layer including a fluid management body, a sample port defined in the fluid management body, an assay strip encased in the fluid management body along a fluid path, a valve defined on the assay strip, and a first internal vent having a first vent inlet, a first vent outlet, and a first venting channel connecting the first vent inlet to the first vent outlet, wherein the first vent inlet is arranged at a first location in the fluid management body along the fluid path downstream of the valve, and the first vent outlet is at a second location in the fluid management body upstream of the valve.

### CROSS REFERENCE TO RELATED APPLICATIONS/PRIORITY

The present invention claims priority to U.S. Provisional Patent Application No. 63/504,918 filed May 30, 2023, which is incorporated by reference into the present disclosure as if fully restated herein. Any conflict between the incorporated material and the specific teachings of this disclosure shall be resolved in favor of the latter. Likewise, any conflict between an art-understood definition of a word or phrase and a definition of the word or phrase as specifically taught in this disclosure shall be resolved in favor of the latter.

### BACKGROUND

Some current devices for genetically identifying disease via biochemical assays risk environmental contamination with potentially infectious samples or assay products and loss of assay volume to the environment through evaporation during heating. Carry-over contamination by sample or assay product in the environment can be a significant problem wherever genetic assays are performed, as even small amounts of carry-over contamination can cause false positives in some or all subsequent genetic assays prepared in the presence of the carry-over contamination. Current rapid diagnostic tests (RDTs), which typically employ a low-cost, paper-based format to maximize accessibility, are incompatible with genetic assays because the former potentially allow air in their constituent porous materials to escape to the open environment as their materials draw fluids forward by capillary action, and potentially provide insufficient mitigation of carry-over contamination in genetic assays when the technologies are paired. Further, because samples and reagents may need to be added, most existing RDTs fail to account for sealing the sample pad after deposition, creating a potential point for evaporation or aerosolization to occur. Some RDTs introduce a high potential for user error and/or increase the risk of carry-over contamination, which limits the accessibility of most genetic testing to central laboratories with trained staff and supporting infrastructure.

Current genetic assay may be operated with reagent mixtures in sealed tubes that require highly trained users to manually handle fluids and expensive laboratory equipment and infrastructure to ensure intended outcomes. Current genetic assay tests may also fail to mitigate unintended or undesired outcomes of operating nucleic acid assays in training- or equipment-free formats open to the environment.

### SUMMARY

Wherefore, it is an object of the present invention to overcome the above-mentioned shortcomings and drawbacks associated with the current technology.

The present invention is directed to methods, apparatuses, and testing devices comprising a fluid management layer including a fluid management body, a sample port defined in the fluid management body, an assay strip encased in the fluid management body along a fluid path, a valve defined on the assay strip, and a first internal vent having a first vent inlet, a first vent outlet, and a first venting channel connecting the first vent inlet to the first vent outlet, wherein the first vent inlet is arranged at a first location in the fluid management body along the fluid path downstream of the valve, and the first vent outlet is at a second location in the fluid management body upstream of the valve. According to a further embodiment, the testing device comprises a second internal vent including a second vent inlet, a second vent outlet, and a second venting channel connecting the first vent inlet to the first vent outlet, wherein the second vent inlet is arranged at a third location in the fluid management body along the fluid path downstream of the valve and upstream of the first vent inlet, and the second vent outlet is at a fourth location in the fluid management body upstream of the valve. According to a further embodiment, the assay strip contains a nucleic acid amplification pad on an amplification side of the valve, and both a reagent labeling pad and a detection pad are on a detection side of the valve. According to a further embodiment, the assay strip further comprises a sample distributor pad spaced from the valve by the amplification pad and a wick pad spaced from the valve by the reagent labeling pad and the detection pad. According to a further embodiment, the second venting channel fluidically merges with the first venting channel, the second location is also the fourth location, and the second vent outlet is defined by the first vent outlet. According to a further embodiment, three first vent outlets are defined in the fluid management body, fluidically connected to the first venting channel. According to a further embodiment, the testing device comprises a debubbler with a debubbler inlet fluidly connected to a debubbler outlet along a debubbler path, where the debubbler inlet is arranged at a fifth location in the fluid management body along the fluid path upstream of the valve and downstream of the sample port, and the debubbler outlet is downstream the debubbler path from the debubbler inlet, where the debubbler path is fluidly connected to the sample port. According to a further embodiment, the debubbler inlet is fluidly connected to the debubbler outlet by an apex bridge, where the apex bridge is vertically spaced further from the assay strip than the debubbler inlet and/or the debubbler outlet. According to a further embodiment, the debubbler outlet is fluidly connected to the first venting channel. According to a further embodiment, the sample distributor pad overlaps a majority but not all of the application pad at a distributor/application overlap. According to a further embodiment, the valve is one of a wax strip valve, a dissolving valve, an electrically stimulated hydrophobic valve, and a thermally stimulated hydrophobic valve. According to a further embodiment, the testing device comprises a heating layer adjacent to the fluid management layer. According to a further embodiment, the heating layer comprises one of an amplification heater, a valve heater, and both an amplification heater and a valve heater. According to a further embodiment, the testing device comprises a heat spreader spacing the one or more heaters from the fluid management layer. According to a further embodiment, the testing device comprises a battery layer functionally connected to the one or more heaters of the heating layer. According to a further embodiment, the testing device comprises a number of laminate layers, where the number is between 3 and 12. According to a further embodiment, the amplification pad is made from one or more porous materials, is blocked with reagents to keep a nucleic acid amplification reaction from sticking to the one or more porous materials, and is impregnated with loop-mediated isothermal amplification reagents mixed with excipients and then lyophilized, the reagent labeling pad is made from one or more porous materials, and is blocked and sprayed with one or more of conjugates, anti-FITC antibodies, and affinity reagents specific to small molecules and that are attachable to an oligonucleotide; and, the detection pad is made from porous nitrocellulose and has one or more test lines to capture labeled amplicons and one or more control lines to capture one or more internal positive control products and free conjugates.

The presently disclosed invention is further related to a kit comprising a testing device comprising a fluid management layer having a fluid management body, a sample port defined in the fluid management body, an assay strip encased in the fluid management body along a fluid path, a valve defined on the assay strip, with the assay strip containing a nucleic acid amplification pad on an amplification side of the valve, and both a reagent labeling pad and a detection pad on a detection side of the valve, and a first internal vent having a first vent inlet, a first vent outlet, and a first venting channel connecting the first vent inlet to the first vent outlet wherein the first vent inlet is arranged at a first location in the fluid management body along the fluid path downstream of the valve, and the first vent outlet is at a second location in the fluid management body upstream of the valve, and a seal layer sealing the fluid management layer, and a dropper tube with liquid reagents stored within, and a swab.

The presently disclosed invention is further related to a system comprising a testing device comprising a fluid management layer having a fluid management body, a sample port defined in the fluid management body, an assay strip encased in the fluid management body along a fluid path, a valve defined on the assay strip, with the assay strip containing a nucleic acid amplification pad on an amplification side of the valve, and both a reagent labeling pad and a detection pad on a detection side of the valve, and a first internal vent having a first vent inlet, a first vent outlet, and a first venting channel connecting the first vent inlet to the first vent outlet wherein the first vent inlet is arranged at a first location in the fluid management body along the fluid path downstream of the valve, and the first vent outlet is at a second location in the fluid management body upstream of the valve, and a seal layer sealing the fluid management layer, and a dropper tube with liquid reagents stored within, a swab, a standalone sample preparation module, and a standalone power module for heating the testing device to an appropriate temperature for amplification. According to a further embodiment, the power module also actuates the valve at a point in time after the amplification is started.

“Nucleic acid amplification test” (NAAT) may refer to tests that first amplify (or make copies of) a target nucleic acid sequence and then detect these copies of the target sequence.

“Nucleic acid” may refer to a polymeric form of nucleic acids of any length or strandedness (double or single); either ribonucleotides (RNA) or deoxyribonucleotides (DNA); and hybrid molecules (comprising DNA and RNA), or derivatives of these molecules. The disclosed nucleic acids may also include naturally occurring and synthetic or non-natural nucleobases. Natural nucleobases include adenine (A), thymine (T), cytosine (C), guanine (G), and uracil (U).

“Positive temperature coefficient ink” or PTC ink may refer to a conductive ink that may be printed. PTC ink can be used to produce heat. PTC ink is commonly applied onto a substrate that is both thin and flexible, often consisting of a polymer material. Depending on the specific requirements of the application, such as the desired temperature, different types of PTC inks may be utilized either alone or in combination.

“Phase change materials” (PCMs) are materials that can absorb or emit latent heat as they transition between physical states, such as from solid to liquid or from liquid to solid. Consequently, PCMs can be used to maintain a consistent temperature, which is generally determined by the melting point of the PCM, in their vicinity despite fluctuations in the external temperature.

“Lamination-based manufacturing” may refer to manufacturing processes that involve printing, lifting, depositing, or otherwise transferring materials from a rolled or flat sheet on one layer to another or combining such layers through lamination or modifying such layers through cutting, molding, etching, or surface modification, all in a continuous fashion. This process can include reel-to-reel and sheet-to-sheet manufacturing methods as well as hybrid manufacturing methods. For example, a device disclosed herein may largely be manufactured by laminating the layers of the device together using reel-to-reel or sheet-to-sheet, but may include certain components produced via other high-volume, low-cost methods such as injection molding.

“Nucleic acid amplification” may refer to the creation of copies of a specific nucleic acid sequence in a continuous, usually exponential fashion. Nucleic acid amplification can occur at a set temperature (also called isothermal amplification) or by cycling through different temperatures (e.g., PCR).

“Amplicons” may refer to copies of nucleic acid sequences created through nucleic acid amplification.

“Isothermal nucleic acid amplification” may refer to nucleic acid amplification performed at a set temperature.

In some embodiments, the testing device and method comprise a multi-layered layout, preferably with functionality on each layer as well as fluidic, thermal, and/or electronic connections between the layers and/or to external components. Each layer can be customized through additional converting steps such as printing or other deposition of reagents, conductors, resistive heaters, and power-generating elements. The layers are preferably assembled using lamination-based manufacturing methods. Embodiments of the disclosed device and method enable highly sensitive integrated amplification and detection of nucleic acid markers associated with disease states—for example, specific pathogen DNA or RNA sequences for infectious diseases—ideally without the need for any instrumentation in a self-contained, disposable device but, in some embodiments, in combination with an external reusable power and/or heat source and/or a sample preparation device.

Preferred embodiments of the disclosed device and method integrate isothermal nucleic acid amplification and detection as substantially distinct assay steps, with the amplification step preferably between 80.00%-99.999% complete, more preferably between 90.00% and 99.00% complete, and most preferably between 95.00% and 98.00% complete before the detection step begins, with a valve to control and/or delay automated transfer between these steps. Some embodiments seek to mitigate amplicon contamination and evaporation occurring as a result of the amplification and detection steps. Additionally, heating, the power source for heating, and time control for heating and valve opening may be integrated into one or more additional layers. Sample preparation, such as removal of inhibitors to downstream assay steps, may also be integrated as a separate layer, or portion of a layer, that contains reagents or structures for these purposes. Such structures may include filters and/or heating layers. In some embodiments, additional layers may include circuitry layers, embossed layers to direct the flow of fluids and/or exert pressure onto adjacent layers, insulating layers, and heat-directing layers, for example. Materials may be printed on various of these layers, including materials designed to conduct current, materials designed to serve as reagents, and/or materials designed to control fluid flow within porous structures.

Embodiments of the present disclosure pertain to nucleic acid assay comprising a multi-layered layout that combines multi-step assay fluidics with preferably low-cost manufacturability. Such a layout preferably provides one or more functional zones across layers or portions of layers for the fluidic management of sample introduction and preparation, multi-reagent rehydration, nucleic acid amplification, and nucleic acid detection. This multi-layered layout may be made of porous materials, plastic and/or other solid material sheets, and adhesive layers, among other materials, in such a manner as to create distinct zones of functionality that maximize the manufacturability and usability of the nucleic acid assay test.

In a preferred embodiment, a reagent mixture required for nucleic acid amplification and labeling of an amplification product for detection is retained in an amplification pad within an amplification zone defined by all or a portion of one or more layers. The amplification pad may comprise, for example, a pad or a chamber on or in which an amplification reaction takes place. In some embodiments, additional reagents in the amplification pad may include capture reagents for the removal of inhibitors such as hemoglobin, degradation reagents for the prevention of assay contamination, and/or dissolving reagents for fluidic valves. Reagent mixtures may be striped, sprayed, printed, and/or otherwise deposited on part of the amplification pad. The reagent mixture can be dried and/or lyophilized during or after depositing it on the amplification pad to enable long-term storage of the reagents, which reduces the required reagent addition steps from the user. This amplification zone may be in direct or valve-switchable fluidic contact with a detection zone designed to detect amplicons created by an amplification reaction contained within the amplification zone. In some embodiments, the amplification pad is thermally coupled with an amplification heater to provide the heat necessary for nucleic acid amplification or fluidic valving to occur successfully. In a preferred embodiment, the amplification pad is sealed within the amplification zone by a portion of a layer that a user can manipulate. A sealed amplification zone is important to prevent the escape of amplicons to the environment, which can cause false positives through carry-over amplification in subsequent nucleic acid amplification tests, and to prevent the evaporation of liquid from the amplification reaction, which can cause invalid or false negative tests.

The presently disclosed invention also contemplates embodiments consisting of a system that encapsulates the disclosed features within discrete components of a low-cost kit. Such a kit would preferably include one or more powered, reusable components that consumable components are inserted into for purposes of preparing samples to obtain amplifiable nucleic acids, heating the amplification zone, timing and actuating fluidic valves, and operating the system on battery power, among other purposes. In some embodiments, a consumable component is designed to be accepted by a powered, reusable component in one orientation only to reduce the incidence of user error in settings wherein the user may have less training.

In preferred embodiments, the layers described herein are manufactured using a lamination-based manufacturing technique. This technique allows the printing of features or graphics onto each layer as well as the integration of all layers into a single “laminated” cassette on a single assembly line, thereby reducing manufacturing costs and allowing fast, high-volume production.

In embodiments wherein a lamination-based manufacturing process requires encapsulation of electrical or electronic layers to prevent contact with other components or layers, a partial or full insulative layer is preferably added to provide the encapsulation of electrical or electronic layers.

In embodiments where thicker components do not follow planar geometry, “spacer” layers are preferably added to allow for those thicker components while still enabling planar or laminate construction.

In some embodiments, manufacturing or design limitations or designs that reduce part count or assembly complexity, for example, it may be preferable that certain components of the testing device be manufactured using low-cost methods other than lamination, such as injection molding. Those components might then be inserted using pick-and-place manufacturing. Limiting the number of components assembled with pick-and-place methods allows for low-cost products enabled by the devices, systems, and methods disclosed herein. Embodiments that reduce the number of assembled parts may be preferred where even non-lamination-based manufacturing is demonstrably less expensive.

Lamination-based manufactured LFAs would be much less expensive and allow a much higher production volume than cassette-based LFAs that require a pick-and-place operation to place the LFA strip into the cassette. However, features such as ridges or protrusions in cassettes often also serve to direct, focus, or control fluid flow in lateral flow materials. Manufacturing LFAs in a conventional reel-to-reel does not allow for such features. This present disclosure includes the use of an embossed layer, made either of a porous material or inert plastic, that replicates these features and can be assembled in the same high-volume, low-cost manner as the rest of the lateral flow layers.

In some embodiments, such embossed layers may also serve to exert pressure onto adjacent layers. As changes in pressure can have a significant effect on fluidics, in that pressure is inversely proportional to saturation in porous materials, embossed layers can be used to tune the fluidic performance of adjacent layers. For example, low-pressure zones may exist at overlaps between distinct materials in the fluidic path, for example, in the detection zone where a layer such as glass fiber that contains labeling reagents is overlapped and in fluidic contact with a layer such as nitrocellulose that contains capture reagents. Exerted pressure from an embossed layer can serve to regulate fluid flow out of the glass fiber and into the nitrocellulose, which enables proper fluidic performance in the detection zone, for example.

Various objects, features, aspects, and advantages of the present invention will become more apparent from the following detailed description of preferred embodiments of the invention, along with the accompanying drawings in which like numerals represent like components. The present invention may address one or more of the problems and deficiencies of the current technology discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

### BRIEF DESCRIPTION OF THE DRAWINGS

The accompanying drawings, which are incorporated in and constitute a part of the specification, illustrate various embodiments of the invention and, together with the general description of the invention given above and the detailed description of the drawings given below, serve to explain the principles of the invention. It is to be appreciated that though the accompanying drawings in FIGS. 1, and 3-15 are to scale, the emphasis is instead placed on illustrating the principles of the invention. The invention will now be described, by way of example, with reference to the accompanying drawings in which:

FIG. 1 is a schematic exploded top view of a testing device according to an embodiment of the presently disclosed invention;

FIG. 2 is a schematic sectional side view of the testing device of FIG. 1, along section lines F2 in FIG. 1;

FIG. 3 is an isometric view of an embodiment of an assay strip, as currently disclosed;

FIG. 4 is a schematic exploded isometric view of a testing device according to a further embodiment of the presently disclosed invention, the testing device having a second port for introducing fluid below the fluid management layer, positive temperature coefficient (PTC) self-regulating ink heaters, and battery systems including fluid-activated paper;

FIG. 5 is a top view of a reagent delivery container of an embodiment of the presently disclosed invention;

FIG. 6 is a side view of the reagent delivery container of FIG. 5; and

FIG. 7 is a schematic view of a kit and method of an embodiment of the presently disclosed invention;

FIG. 8 is a schematic view of a workflow of an embodiment of a testing device system according to the presently disclosed invention, including photographs of embodiments of the testing device, sample prep module, and power module;

FIG. 9 is a schematic view of the architecture of the testing device system of FIG. 8;

FIG. 10 is an exploded view of the testing device of FIG. 8;

FIG. 11A is a partially see-through isomeric view of the testing device of 10, and FIG. 11B is an isomeric view of the testing device of FIG. 8;

FIG. 12 is a close-up view of the testing device of 13B along the box F14, showing the debubbler and vent outlets;

FIG. 13 is a top-view photograph of the testing device of FIG. 8;

FIG. 14 is a photograph of the sample prep module of FIG. 8; and

FIG. 15 is a photograph of the power module of FIG. 8.

### DETAILED DESCRIPTION

The present invention will be understood by reference to the following detailed description, which should be read in conjunction with the appended drawings. It is to be appreciated that the following detailed description of various embodiments is by way of example only and is not meant to limit, in any way, the scope of the present invention. In the summary above, in the following detailed description, in the claims below, and in the accompanying drawings, reference is made to particular features (including method steps) of the present invention. It is to be understood that the disclosure of the invention in this specification includes all possible combinations of such particular features, not just those explicitly described. For example, where a particular feature is disclosed in the context of a particular aspect or embodiment of the invention or a particular claim, that feature can also be used, to the extent possible, in combination with and/or in the context of other particular aspects and embodiments of the invention, and in the invention generally. The terms “comprise(s),” “include(s),” “having,” “has,” “can,” “contain(s),” and grammatical equivalents and variants thereof, as used herein, are intended to be open-ended transitional phrases, terms, or words that do not preclude the possibility of additional acts or structures. are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components. The singular forms “a,” “and” and “the” include plural references unless the context clearly dictates otherwise. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

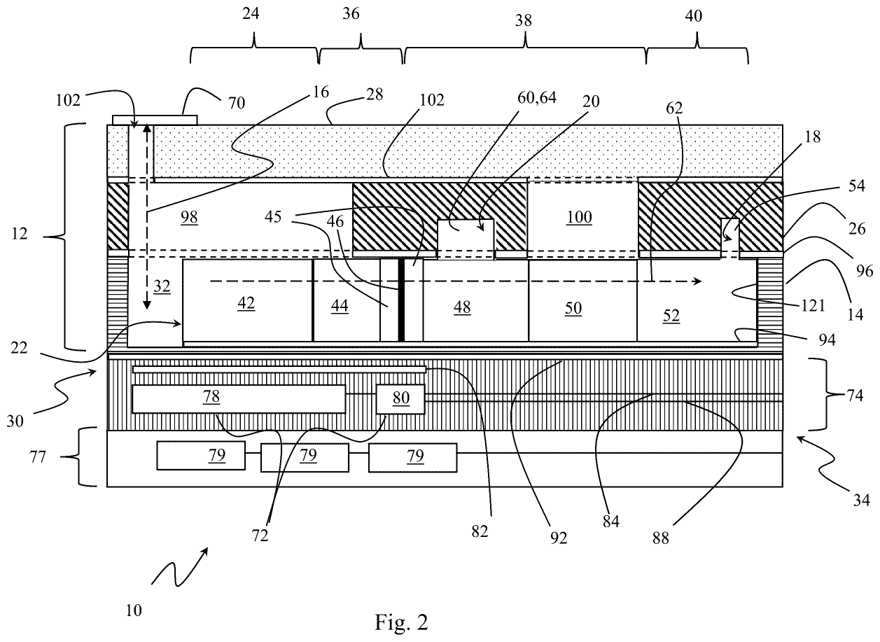

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm. Where spatial directions are given, for example above, below, top, and bottom, such directions refer to the testing device as represented in FIG. 2, unless identified otherwise.

The embodiments set forth below represent the necessary information to enable those skilled in the art to practice the invention and illustrate the best mode of practicing the invention. For the measurements listed, embodiments including measurements plus or minus the measurement times 5%, 10%, 20%, 50%, and 75% are also contemplated. For the recitation of numeric ranges herein, each intervening number therebetween with the same degree of precision is explicitly contemplated. For example, for the range of 6-9, the numbers 7 and 8 are contemplated in addition to 6 and 9, and for the range 6.0-7.0, the number 6.0, 6.1, 6.2, 6.3, 6.4, 6.5, 6.6, 6.7, 6.8, 6.9, and 7.0 are explicitly contemplated.

The term “substantially” means that the property is within 80% of its desired value. In other embodiments, “substantially” means that the property is within 90% of its desired value. In other embodiments, “substantially” means that the property is within 95% of its desired value. In other embodiments, “substantially” means that the property is within 99% of its desired value. For example, the term “substantially complete” means that a process is at least 80% complete, for example. In other embodiments, the term “substantially complete” means that a process is at least 90% complete, for example. In other embodiments, the term “substantially complete” means that a process is at least 95% complete, for example. In other embodiments, the term “substantially complete” means that a process is at least 99% complete, for example.

The term “substantially” includes a value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

The term “about” includes when value is within about 10% of the indicated value. In certain embodiments, the value is within about 5% of the indicated value. In certain embodiments, the value is within about 2.5% of the indicated value. In certain embodiments, the value is within about 1% of the indicated value. In certain embodiments, the value is within about 0.5% of the indicated value.

In addition, the invention does not require that all the advantageous features and all the advantages of any of the embodiments need to be incorporated into every embodiment of the invention.

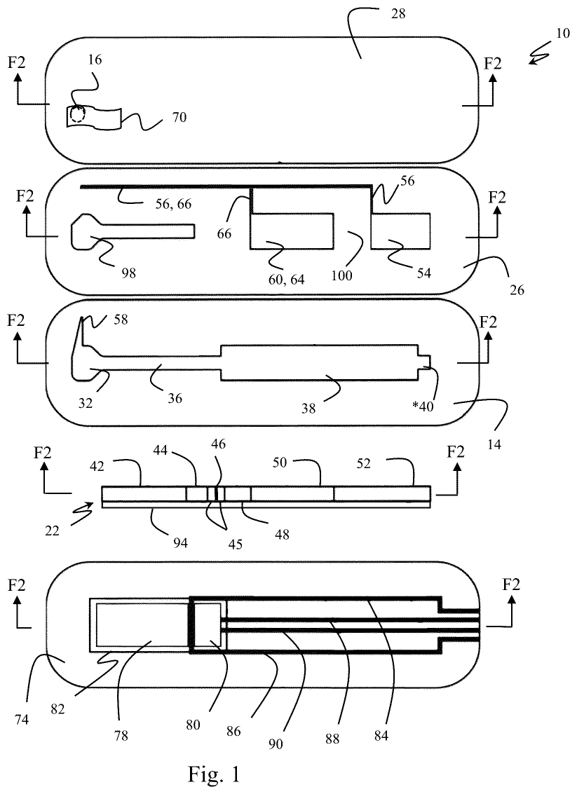

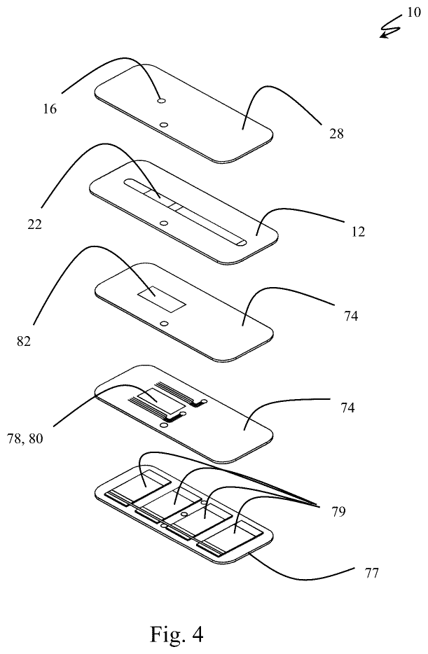

Turning now to FIGS. 1-15, a brief description concerning the various components of the present invention will now be briefly discussed. As can be seen in FIGS. 1 and 2, the testing device 10 comprises a fluid management layer 12 having a fluid management body 14 with multiple fluid zones, a sample port 16, a first internal vent 18 and preferably a second internal vent 20, and an assay strip 22. The fluid management layer 12 preferably further comprises a vent layer 26, and a seal layer 28, with the vent layer 26 preferably spacing the fluid management 12 from the seal layer 28. These elements and further embodiments will be described below.

Further describing the fluid management body 14, at a port end 30 of the fluid management body 14 is a lower sample port 32. Moving toward a wick end 34 of the fluid management body 14, opposite to the port end 30, the lower sample port 32 leads into and joins with a sample preparation zone 24, then to an amplification zone 36 defined by an upstream flow channel, which preferably widens to form a detection zone 38, defined by a downstream flow channel, and then preferably narrows to form a strip registration channel 40 at the wick end 34 of the fluid management body 14, traversing from the port end 30 to the wick end 34 of the fluid management body 14. These fluid zone channels 24, 36, 38, 40 are preferably in fluid connection with one another and surround the assay strip 22.

The assay pad or strip 22 preferably comprises multiple strip zones, including a porous sample distributor pad 42, a porous amplification pad 44, a porous valve pad 45, a valve 46, a porous reagent labeling pad 48, a porous detection pad 50, and a porous wick pad 52. The multiple strip zones are preferably directly connected to each other. In an embodiment, one or more strip zones are of unitary construction with an adjacent strip zone. In a preferred embodiment, one, some, or all of the strip zones are not of unitary construction with one or both adjacent strip zones. The assay strip 22 is preferably positioned in one, more, or all of the fluid zone channels 24, 36, 38, 40, with the distributor pad 42 adjacent to the port end 30 of the fluid management layer 14 and the wick pad 52 adjacent to the wick end 34 of the fluid management layer 14. Details of various embodiments of the strip zones 42, 44, 45, 48, 50, 52 are described below.

In an embodiment, impermeable layers are laminated onto or partially or fully around the assay strip 22. The closed environment counteracts capillary action pulling fluid toward the wick 52 with back-pressure due to trapped air. This back pressure could thus cause the lateral flow assay to fail to operate correctly. In an embodiment of the testing device 10, the fluid management layer 14 and/or the vent layer 26 has one or more pockets and/or channels defined therein, which form one or more internal vents 18, 20. In an embodiment, the detection zone 38 and/or the strip registration channel 40 is vented via the first internal vent 18 at a distance from the amplification zone 36, preferably over the wick pad 52. In a preferred embodiment, the first internal vent 18 relieves the back pressure. The first internal vent 18 is preferably a recirculating vent, with a first vent inlet 54, a first venting channel 56, and a first vent outlet 58. This allows fluids progressing down the assay strip 22, pulled forward by capillary action, to push air into the first vent inlet 54, be recirculated through the first venting channel 56, and out of the first vent outlet 58 to an area upstream of the amplification zone 36, such as into the lower sample port 32. This helps to equalize pressure within the fluid management layer 12 along the assay strip 22, to allow capillary action to accomplish the fluid transport.

In an embodiment, a second internal vent 20 in the form of a preferably concave chamber 60 sits vertically above the fluid path 62 in the detection zone 38, preferably just downstream of the valve 46 to capture and condense vapor from the amplification zone 36, especially in situations when the amplification zone 36 is warm or hot, in a way that helps keep the condensate from contacting the porous materials of the downstream detector pad 38 of the assay strip 22. In some embodiments, the chamber 60 may contain a porous material, such as cellulose or cotton, laminated to a top surface of the chamber 60 to absorb and contain condensation. In an embodiment, the chamber 60 and/or other parts of the device may be formed from air-permeable but amplicon-impermeable layered materials such as expanded PTFE to act as a sealant and help prevent one or more of amplicon contamination of the environment, reagent carry-over, loss of liquid through evaporation, and deformation or delamination of sealed layers. In an embodiment, the second internal vent 20 could additionally or alternatively include a second vent inlet 64, a second venting channel 66, and a second vent outlet 68, all in fluid connection. In some embodiments, the chamber 60 may act as one or more of these. The second vent outlet 68 would preferably be located in the lower sample port 32. In an embodiment, the second venting channel 64 may be completely or partially separate from the first venting channel 56, and/or the second vent outlet 68 could be completely or partly separate from the first vent outlet 58. In an embodiment, the second venting channel 66 may extend from the second vent inlet 64 and merge with the first venting channel 56, and/or the first venting outlet 58 may function as the second venting outlet 68 as well.

In an embodiment, one or more of the vent inlets 54, 64, venting channels 56, 66, and/or vent outlets 58, 68 may be shifted vertically up and/or horizontally to the side of the assay strip 22, and/or vertically down and/or horizontally to the side of the assay strip 22.

In a preferred embodiment, all or a portion of the device is sealed by a user after the introduction of the sample and reagents, including when the testing device is an integrated multi-layer layout. This may be accomplished by a sealing cover 70. In some embodiments, the sealing cover 70 is a sealing sticker or a flap that allows sealing or resealing by the user after depositing the liquids into the assay. This sealing cover 70 may comprise a removable top layer over the sample distributor pad 42 that can be removed partially or completely to allow for sample and reagent deposition and then reattached after deposition is complete, for example using pressure-sensitive adhesives. In other embodiments, the sample port 16 over the sample distributor pad 42 can initially be open, and a custom sticker included with the device can be placed by the user over the pad after the sample and reagents have been deposited. In other embodiments, the sample port may be initially covered by the sealing cover 70, which is opened to allow the sample and reagents to be deposited, and then recovered by the cover 70. The covering by cover 70 will preferably permanently seal the input port to prevent evaporation and amplicon escape.

ASSAY STRIP: Uniform rehydration of the reaction mixture by an added sample, which is an enhanced functionality compared to the lateral flow of a sample directly applied to the amplification pad 44, is enabled by the arrangement of the sample distributor pad 42 and the amplifying pad 44, the materials used to create each, and the application to and dry storage of the reagent mixture in one or both strip zones 42, 44. Materials, sizes, and arrangements are preferably selected such that the distributor pad 42, with any dried reagents contained within, preferably has a faster lateral fluid flow rate than the material selected for the amplification pad 44, with the dried reaction mixture contained within. The design of such an embodiment takes advantage of the faster lateral fluid flow rate into and through the distributor pad 42 than the relatively slower vertical and lateral fluid flow rate into and through the amplification pad 44. This enables relatively or substantially completely uniform reagent rehydration within the amplification zone 36, which substantially improves the efficiency of the amplification reaction.

The valve 46, in general, provides for the retention of the reagent mixture in the amplification zone 36, and then, upon the substantial completion of the amplification reaction, creates a fluid opening in the fluid path 62 from the amplification zone 36 into the detection zone 38. In the detection zone 38, the fluid flows through the reagent labeler 48 that stores dried labeling reagents, such as antibodies conjugated to colored nanoparticles, which bind with amplicons generated by the amplification reaction. The fluid then flows through detector 50 comprising, preferably, at least two detection areas, such as test lines 51 and control lines 53, preferably with capture reagents, such as capture antibodies, striped onto the nitrocellulose pad as lines. The detection areas 51, 53 capture and concentrate labeled amplicons generated by the amplification reaction, for example, in the presence of one or more target nucleic acids or as a control reaction to indicate proper operation of the test. In a preferred embodiment, the detection areas 51, 53 are lines of capture antibodies striped onto nitrocellulose, which capture and concentrate amplicons labeled by nanoparticle-antibody conjugates such that positive, valid test results can be interpreted by the naked eye. The wick 52, located at the end of the fluid path 62 in the detection zone 38 and the strip registration channel 40, is designed to draw the sample and reagent fluids through the assay strip 22 along the fluid path 62 and substantially absorb the fluids at the end of the fluid path 62. In some embodiments, the fluid path 62 between the amplification zone 36 and the detection zone 38 is created by opening a timed and triggered fluidic valve 46. Not shown, a second valve 46, formed as any of the valve types listed herein, can be used to controllably fluidically separate the sample preparation zone 24 from the amplification zone 36.

VALVE: The present disclosure provides several alternative valve 46 types, including wax, dissolving, electrically stimulated hydrophobic, or thermally stimulated hydrophobic, for example, that may be used depending on the specific situations. Examples of wax valves 46 include a bolus of fluid-impermeable wax that is printed into a porous layer separating the amplification zone 36 from the detection zone 38. A heating layer 74 or external heating device 76 in direct or indirect contact with the wax valve 46 can, upon activation, melt the wax in the valve 46, thus allowing fluid to pass. Heating layers 74 for this purpose can be timed electronically or fluidically, for example, if the heater source 72 is exothermic and activated by water passing through a separate porous layer element. Embodiments of the heating layer 74 and external heating device 76 are discussed in more detail below. Some alternatives to wax valves 46 include electrically or thermally stimulated hydrophobic materials like copper/copper oxide surface or Poly(N-isopropylacrylamide) coated surfaces, respectively.

In an embodiment, the fluidic valve 46 comprises a printed wax structure on a porous valve pad 45 that seals the fluid path 62 until the wax is melted by a heat source 72, opening the fluid path 62. This melting can be accomplished by heating with a PTC ink 72, an electronically regulated resistive heater 72, or an exothermic material 72 with or without a PCM. The melting can be trigger-timed electronically or via a paper fluidic fuse, for example. In an embodiment, a paper strip wicks fluid in a controlled, time-reproducible manner, the length of which is proportional to the time desired for the valve 46 action. Once the fluid reaches the exothermic material 72, the heating process—and thus the wax melting and the valve 46 opening—is triggered. In some embodiments, the degree of heating of the amplification zone 36 may create vapor pressure that could induce premature failure of a seal of the wax valve 46, especially at the interface of the wax of the valve 46, amplification pad 44, and fluid management body side wall 75. An embodiment of this invention uses additional sealant material at that interface to ensure no fluid or fluid vapor escapes the amplification zone 36 prior to the timed release of the valve 46.

In an embodiment, a valve 46 based on the swelling of a material along the fluid path 62 opens or closes the fluid path 62. Alternatively, a fluidic fuse can work as a swelling-based valve 46 if fluid wicked via a porous layer to the valve 46 causes the valve 46 to swell due to exposure to the liquid. This then could push one of the layers of the assay strip 22 onto the other, thereby opening or closing the fluid path 62 and opening the valve 46. In an embodiment including an integrated battery layer 77, a chemical change within the battery fluid (e.g., concentration or pH change as a function of substantial discharge of the battery 79) may trigger a conformational change within a stimulus-response polymer material, for example, causing it to swell, shrink, or dissolve, and thus act as a fluidic valve 46 to open or close the fluid path 62. In an embodiment, a chemical property within the amplification reaction itself may trigger a conformational change within a stimulus-responsive polymer material, causing it to swell, shrink, or dissolve, and thus act as a fluidic valve 46 to open or close the fluid path 62.

In an embodiment, a valve 46 based on the completion of the heating process triggers cooling-induced shrinking, bending, or unbending to open or close the fluid path 62. In an embodiment, the valve 46 is comprised of a polymer or electrode that becomes more hydrophilic when a potential is applied to it, thus acting as a fluidic valve 46 to open the fluid path 62. In an embodiment, a valve 46 consists of a slowly dissolvable polymer or barrier, including but not limited to dried sugars, salts, polyethylene glycol, or polyvinyl alcohol, that opens the fluid path 62 as the material dissolves into the amplification reaction mixture. In an embodiment, the valve 46 is comprised of a polymer that becomes more hydrophilic when exposed to a change in pH or temperature, thus acting as a fluidic valve to open the fluid path 62. In an embodiment, an electromagnetic valve 46 is triggered with an electrical current, thus acting as a fluidic valve to open the fluid path 62.

The wick 52 is preferably impregnated with a chemical, such as hypochlorite or iodine, or nucleases. Because amplicons generated in the present disclosure will accumulate in the pad of the wick 52, this will inactivate amplicons and thus reduce carry-over contamination risk. In other exemplary embodiments, amplicon-inactivating absorbing layers containing amplicon-inactivating reagents, such as strong bases or nucleases, are laminated around various, preferably larger, portions of the testing device 10. These amplicon-inactivating absorbing layers would preferably only come in contact with the reagent-containing portions of the device in case of malfunction (overflow, leaking) or tampering.

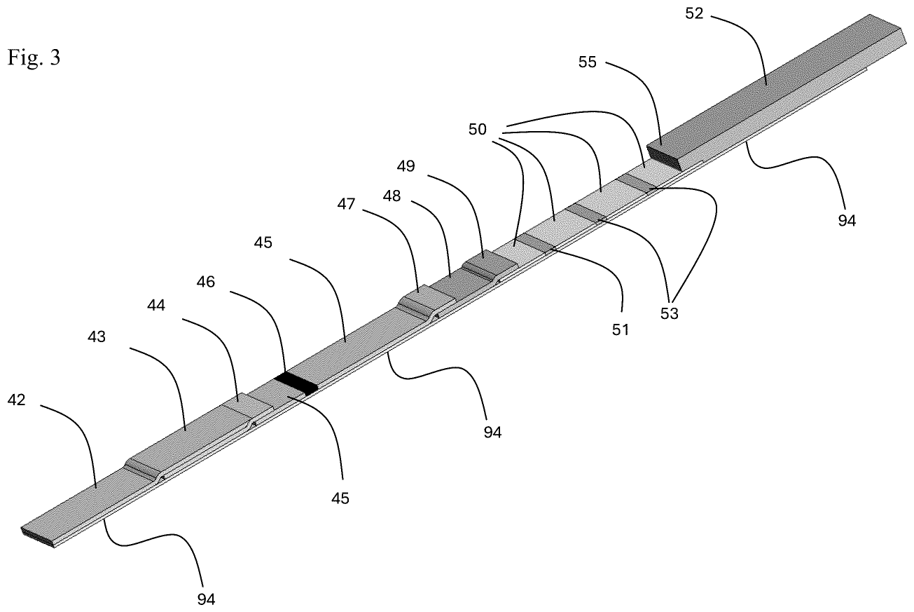

Turning now to FIG. 3, an embodiment of the assay strip 22 is shown. On the bottom left of the page, as shown, the assay strip 22 and the fluid path 62 start with the sample distributor pad 42. The sample distributor pad 42 is preferably porous materials, such as glass fiber, chopped glass with binder, cellulose, polyethersulfone, polyester, sintered polymer bead pads (e.g. Porex TM), that collects a sample by drawing it into the pad and pulling it up and over the lyophilized (i.e. freeze-dried) amplification pad 44. The sample distributor pad 42 is preferably made from a moderately thick, large pore material like glass fiber. In a preferred embodiment, the sample distributor pad 42 is made from Whatman Standard 17 (370 μm thickness at 53 kPA) glass fiber. A distributor/application overlap 43 is the area of the assay strip 22 where a portion of the sample distributor pad 42 overlaps the amplification pad 44. The sample distributor pad 42 is a contiguous material illustrated as changing heights to indicate the overlap of the amplification pad 44. The distributor/application overlap 43 promotes uniform rehydration of the freeze-dried reagents in the amplification pad 44 from above.

The amplification pad 44 is preferably porous materials, such as glass fiber, chopped glass with binder, cellulose, polyethersulfone, polyester, sintered polymer bead pads (e.g. Porex TM), lyophilized with amplification reagents for dry storage of those reagents on board. In a preferred embodiment, the amplification pad 44 is made from Whatman Standard 17 glass fiber, blocked with reagents to keep the amplification reaction from “sticking” to the porous material, and impregnated with loop-mediated isothermal amplification (LAMP) reagents mixed with excipients and then lyophilized. The excipients are added to protect the reagents during the lyophilization process.

The valve pad 45 is preferably porous materials, such as glass fiber, chopped glass with binder, cellulose, polyethersulfone, polyester, sintered polymer bead pads (e.g. Porex TM), to hold the valve 46, here a wax valve 46. In a preferred embodiment, the valve pad 45 is made with Whatman Standard 17 glass fiber and striped with the wax valve 46. In some embodiments, the valve pad 45 is blocked to prevent reaction products from sticking to the porous material. The valve 46 shown is a wax valve 46 striped into the valve pad 45 at a temperature above the melting point of the wax. In a preferred embodiment, a casting wax is used from Freeman TM, and it is striped by a custom robot. After the wax valve 46, the valve pad 45 continues, and at a valve/labeling overlap 47, the wax pad 45 overlaps the reagent labeling pad 48.

The reagent labeling pad 48 is preferably porous materials, such as glass fiber, chopped glass with binder, cellulose, polyethersulfone, polyester, sintered polymer bead pads (e.g. Porex TM), that store dried nanoparticle-antibody conjugates, which label the amplification product for visual detection downstream on the detection pad 50. The conjugates could be any color latex or any type of particle commonly used in LFAs, like colloidal gold cellulose nanobeads and/or anti-FITC or any affinity reagent specific to small molecules that can be attached to an oligonucleotide. In a preferred embodiment, the reagent labeling pad 48 is made from Ahlstrom Grade 8964 chopped glass with a binder, is blocked, is sprayed with conjugates made from blue latex nanoparticles and anti-FITC antibodies, and is dried in an oven. At a downstream portion of the reagent labeling pad 48, the reagent labeling pad 48 overlaps the detection pad 50 at the labeling/detection overlap 49.

The detection pad 50 is preferably in the form of a porous material to preferably visualize the products of the amplification reaction for direct interpretation of the test results by the naked eye. The detection pad 50 is preferably made from a thin, very small, and tight pore material. In a preferred embodiment, the detection pad 50 is made from Sartorius CN95 nitrocellulose. Along the detection pad 50 are preferably test lines 51 and control lines 53, comprising capture reagents striped in specific locations for binding amplification reaction products labeled with conjugates or free conjugates to those specific locations on the detection pad 50, thereby aggregating a visible quantity of conjugate when the product exists. In a preferred embodiment, there is one test line 51 followed by two control lines 53. In a preferred embodiment for use with Tuberculosis (TB), the test line 51 uses polystreptavidin to capture TB LAMP products via a biotin label integrated during positive amplification reactions (e.g., when the genome of the bacterium causing TB is present at more than 2 copies per reaction in the incoming sample). In the embodiment shown, the first control line 53 after the test line 51 uses anti-digoxigenin antibodies to capture Internal Positive Control (IPC) products via a digoxigenin label preferably integrated during an amplification reaction. In the embodiment shown, the second control line 53, after the test line 51, uses Protein A/G to capture free conjugates via the anti-FITC antibodies to act as a flow control (e.g., that the LFA strip transported fluid correctly). At a downstream portion of the detection pad 50, the detection pad 50 overlaps the wick pad 52 at the detection/wick overlap 55.

The wick pad 52 captures fluid transported through the detection pad 50. The wick pad may be made of preferably porous materials, such as, for example, glass fiber, chopped glass with binder, cellulose, polyethersulfone, polyester, sintered polymer bead pads (e.g. Porex TM). Preferably, a thick, porous material like cellulose and/or cotton is used as the fluidic sink. In a preferred embodiment, the wick pad 52 is made from Ahlstrom Grad 440 cotton/glass blend.

In some embodiments, heat from a heat source 72 may be required for the amplification reaction to proceed at an optimal rate and/or for the valve 46 to open and/or close as desired. In some embodiments, the heat source 72 is integrated into the testing device 10, as a heating layer 74, for example. In some embodiments, the heat source 72 is an external heating device 76 that the testing device 10 is positioned in or near to heat the testing device 10. In some embodiments, heat will be supplied to the testing device 10 by an integrated heating layer 74 and an external heating device 76. Some embodiments of the heating source 72 will be described in more detail below.

Turning again to FIGS. 1 and 2, a diagram illustrates the layered structure of an embodiment of the testing device 10. In the embodiment shown, the testing device 10 is comprised of multiple laminated layers. The heating layer 74 includes an amplification heater 78 and a valve heater 80, preferably adjacent to each other and co-located within the boundaries of and underneath a heat spreader 82 adjacent to the port end 30 of the heating layer 74. An amplification heater positive lead 84 and an amplification heater negative lead 86 preferably traverse the heating layer 74 from the wick end 34 of the heating layer 74 and are connected above and in contact with the amplification heater 78. Similarly, a valve heater positive lead 88 and valve heater negative lead 90 traverse the heating layer 74 from the wick end 36 of the heating layer 74, parallel to but not in contact with the amplification heater positive lead 84 and the amplification heater negative lead 86, and are connected together above and in contact with the valve heater 80. Preferably, the entirety or substantially the entirety of the heating layer 74 is affixed via a first adhesive layer 92 to the assay strip 22 and the fluid management layer 12. Inside the fluid management body 14, the distributor pad 42 and the amplification pad 44 are preferably positioned above and in contact with the amplification heater 78. The valve 46 is adjacent to the amplification pad 44 and preferably positioned above and in contact with the valve heater 80.

When this embodiment of the testing device 10 is used, the valve heater 80 heats the valve 46, which may be made of wax. When the wax valve 46 is melted by the valve heater 80, the nucleic acid sample, which was distributed by the sample distributor pad 42 into and amplified within the amplification pad 44, follows the fluid path 62 to the porous reagent labeling pad 48, then subsequently to the porous detection pad 50, and finally to the porous wick pad 52 at the wick end of the fluid management layer 12. Preferably the entirety of the assay strip 22 is affixed to a backing material 94. The fluid management layer 12 is positioned on top of and in contact with the first adhesive layer 92 and thus, the heating layer 74. The fluid management layer 12 is also positioned around the assay strip 22. The channels of the fluid management body surround the assay strip 22. Preferably, the entirety or substantially the entirety of the fluid management layer 12 is affixed with a second adhesive layer 96 to the vent layer 26. The vent layer is preferably positioned on top of and in contact with the second adhesive layer 96, and thus, the fluid management layer 12. The vent layer 96 comprises an upper sample port 98, which is above, in fluid contact with, preferably the same shape and size as, and aligned to the lower sample port 32 at the port end 30 of the fluid management layer 12. Towards the wick end 34 of the vent layer 26, a read window 100 separates the first vent inlet 54 from the second vent inlet 64. The first vent inlet 54 joins the first venting channel 56 and traverses the vent layer 26 back towards the port end of the vent layer 26 parallel to the amplification zone 36 and terminating vertically above the first vent outlet 58 at the port end of the fluid management layer 12. Preferably, the entirety or substantially the entirety of the vent layer 26 is affixed by a third adhesive layer 102 to the seal layer 28. The seal layer 28 is positioned on top of and in contact with the vent layer 26 via the third adhesive layer 102. The seal layer 28 comprises a preferably small sample port inlet 104 at the port end 30 seal layer 28, into which a user deposits a sample. The port inlet 104 is above and aligned to the upper sample port 98 and lower sample port 32, such that after traversing the seal layer 28 and the vent layer 26, a sample deposition results in the sample being placed upstream of the on the assay strip 22 and/or directly onto a portion of the sample distributor pad 42.

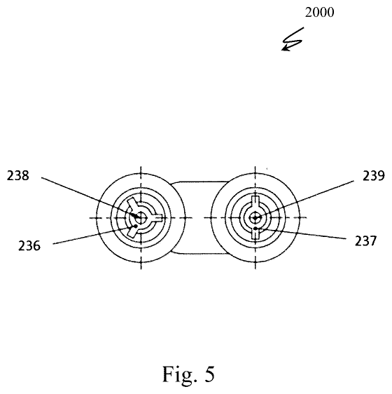

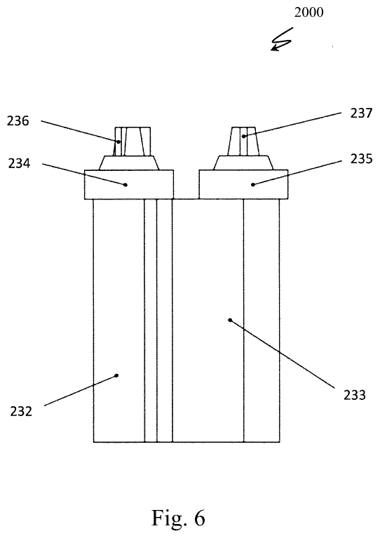

Turning to FIGS. 5 and 6, a reagent delivery system structure compatible with certain embodiments of an assay device is shown. In an embodiment, the reagent delivery system 2000 comprises a substantially cylindrical first liquid portion of dispenser 232 operably coupled at a first male threaded end to a screw cap 234 with a first female threaded end which a user can remove and replace onto the first male threaded end of the first liquid portion of dispenser 232. A second end of the first liquid portion of dispenser 232 is preferably closed. A second end of the screw cap 234 comprises a first keyed portion 236 designed to be inserted into a first sample port of an assay device. The first keyed portion 236 preferably terminates in a first liquid orifice 238 through which liquid in the first liquid portion of dispenser 232 can be dispensed when the first liquid portion of dispenser 232 is squeezed by a user. Attached and parallel to the first liquid portion of the dispenser 232 is a substantially cylindrical second liquid portion of the dispenser 233 coupled at a first end to a preferably fixed cap 235, which a user preferably cannot remove without breaking the dispenser 232. A second end of the second liquid portion of the dispenser 233 is preferably closed. A second end of the fixed cap 235 comprises a second keyed portion 237 with a different design meant to be inserted into a second sample port of an assay device. The second keyed portion 237 terminates in a second liquid orifice 239 through which liquid in the second liquid portion of the dispenser 233 can be dispensed when the second liquid portion of the dispenser 233 is squeezed by a user.

The liquid dispenser 233 may be utilized in an embodiment wherein it is necessary to deliver an initial reagent-and-sample mixture onto the testing device 10 while simultaneously delivering a secondary reagent onto the testing device 10. The liquid dispenser 233 has two compartments, one of which is prefilled with the secondary reagent. In some embodiments, the design includes features making it difficult to deposit the wrong fluid in the wrong receptacle, such as the asymmetric keyed design described above. In some embodiments, the liquid dispenser 233 comprises an asymmetric dual pipette allowing the user to transfer the initial and secondary reagents simultaneously. A first liquid reservoir of such asymmetric dual pipette has a user-removable screw cap fitted with a keyed dispensing port. The user can remove this cap to, for example, insert a sample swab into the premeasured reagent present in the reservoir. A second liquid reservoir of such an asymmetric dual pipette preferably has a fixed cap and is fitted with a keyed dispensing port with a different design. The corresponding embodiment of a laminated assay device preferably has two sample ports with female asymmetric designs meant to fit the keyed dispensing ports of the liquid reservoirs in only the intended orientation to ensure the correct deposition of fluid into the assay.

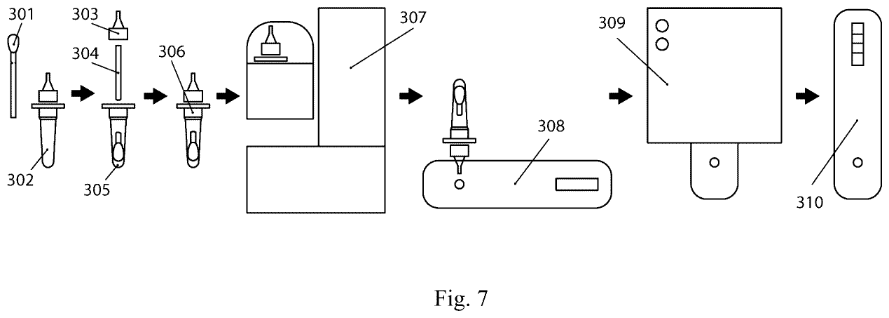

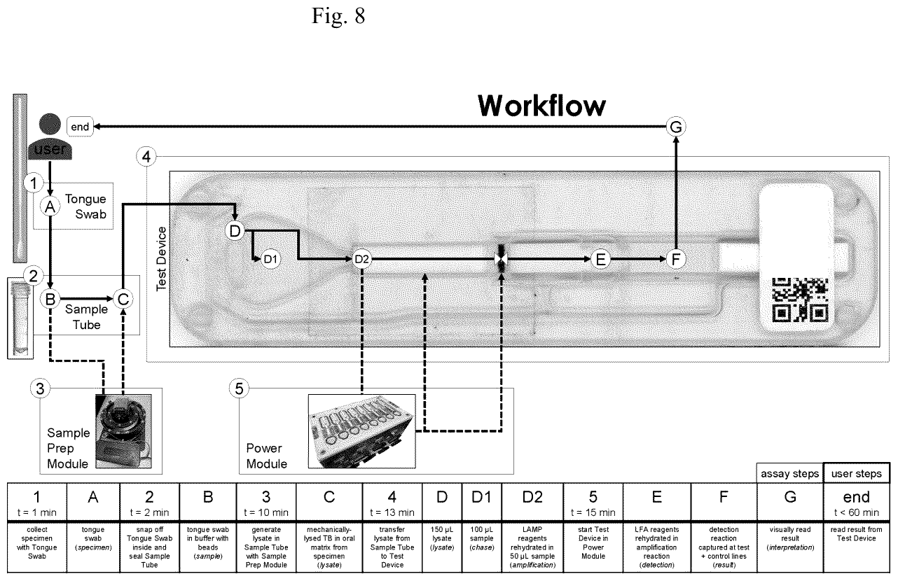

Turning to FIG. 7, a kit embodiment of the testing devices 10, methods, and systems is shown. One such embodiment of the kit in FIG. 7 is shown in FIGS. 8-15. In the embodiment shown in FIG. 7, the sample preparation and timed heating takes place offboard on preferably low-cost, reusable components that accept consumable components that manage the sample and assay fluid. In such an embodiment, the assay is part of a kit including a consumable patient sampling component, such as a swab 301, urine concentrator, or blood capillary; a consumable sample collection tube 302 with a dropper cap 303; an optional, reusable sample preparation module component for samples requiring lysis 307; a reusable power module component 309, and a test device component containing the fluidics and amplification and detection reagents stored dry 308. In one embodiment, the swab 301 with the patient sample has a breakpoint for detaching the head from the shaft 301. The dropper tube 302, which has a removable cap 303, comes packaged with an appropriate volume of liquid reagents 306 for dropper tube 302 and sample prep reagents 306. As shown, the dropper tube 302 and sample prep reagents 306 are shown in their separate state as dropper body with swab head 305. A healthcare worker would remove the cap 303 from the dropper tube 302, place the swab 301 head-down into the reagents 306 in the dropper tube 302 with sample prep reagents 306, break the swab 301 at the breakpoint that includes a swab shaft 304, and replace the dropper tube cap 303. If the sample requires lysis prior to amplification, such as in an assay testing for M. tuberculosis, the dropper tube 302 with the patient sample and swab 301 is then inserted into a slot in the sample preparation module 307. A moveable lid is closed over the top of the dropper tube 302 and the sample preparation module 307 is activated so that the sample is lysed. Once the sample is ready for amplification (with or without lysis), the user squeezes a number of drops from the dropper tube 302 into the sample port of the test device 308. The test device 308 is then inserted into the power module 309, where timed heating sufficient for amplification and valve actuation occurs. Once the operation of the test device 308 by the power module 309 has been heated for the length of time appropriate for the type of assay being conducted, the user removes the device and reads the test result 310.

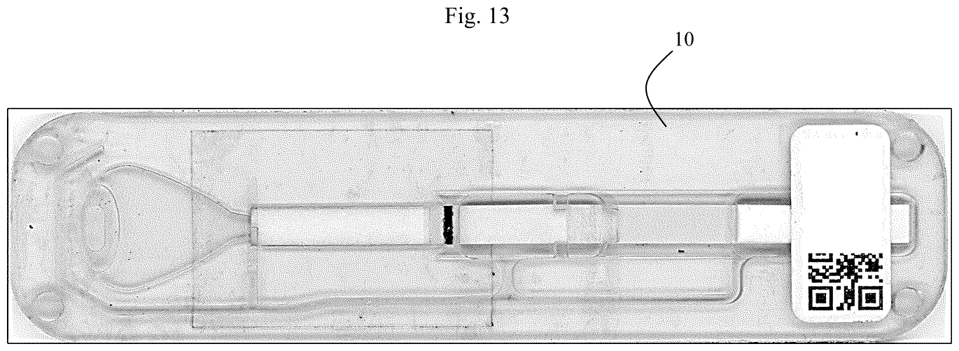

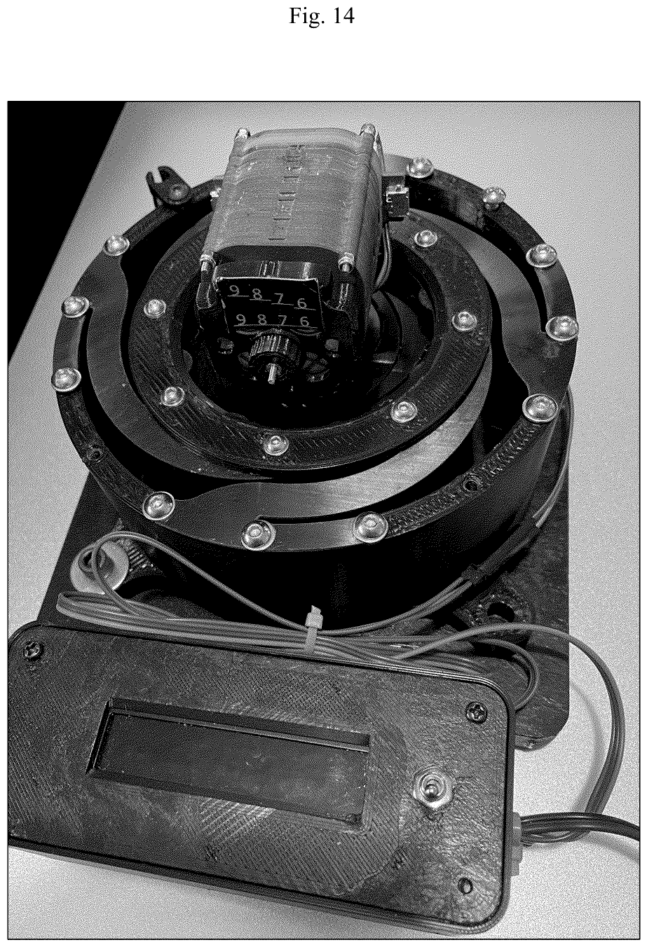

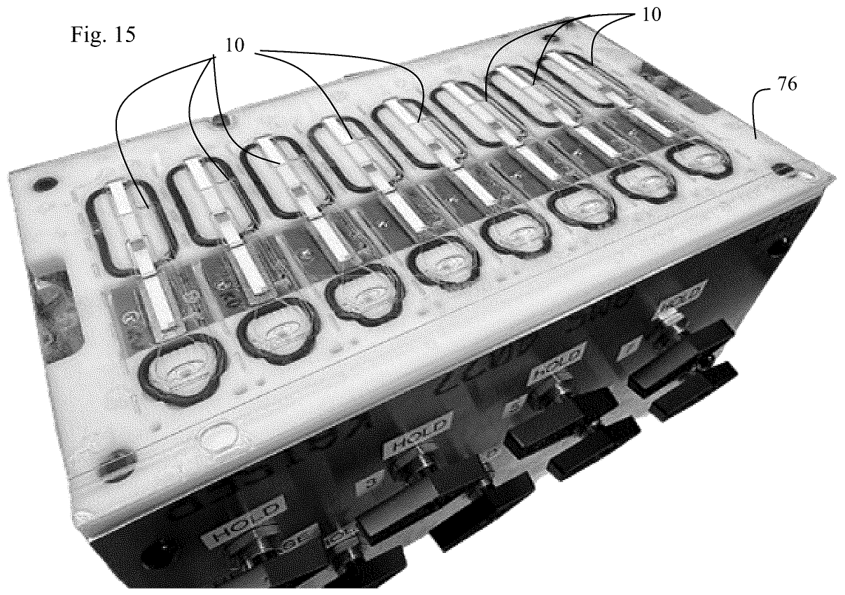

DEBUBBLER: Turning to FIGS. 8 through 15, a further embodiment of the testing device and system is shown. FIG. 8 is a workflow of this embodiment, showing the various steps in the process of this embodiment. In step 1, a swab is used to collect a specimen from a user, for example, from the user's oral or nasal cavity. This step will preferably take around one minute. In step 2, the swab is inserted into a sample tube, snapped off inside the tube, and sealed within the sample tube. The tongue swab is in a buffer with beads. This step will preferably take around 2 minutes. In step 3, the sample tube is inserted into a simple prep module, shown in detail in FIG. 14. This generates lysate. In this step, mechanically lysed TB is generated in an oral matrix from the specimen (lysate). This step will preferably take around 10 minutes. In step 4, the lysate is transferred from the sample tube to the test device 10, shown in detail in FIG. 13. As shown in FIG. 8, preferably 150 microliters of lysate are placed in the sample port 16. This includes preferably 100 microliters of sample (chase) at location D1, and 50 microliters of sample-rehydrated loop-mediated isothermal amplification (LAMP) reagents (amplification) at location D2. This step will preferably take around 13 minutes. In Step 5, the testing device is placed in the power module 76, shown in detail in FIG. 15, and the power module 76 is started. The power module 76 preferably provides heat to accelerate the amplification reaction and to melt/open the valve 45. After the valve 45 is opened at location E, LFA reagents are rehydrated by the sample migrating from the amplification reaction (detection). At location F, the detection reaction is captured at one or more test and control lines (result). At location G, the test results are visually read (interpretation). This step preferably takes around 15 minutes. After interpretation, the assay steps are concluded. The results are read from the test device 10, which ends the process. The whole process will preferably take less than 60 minutes.

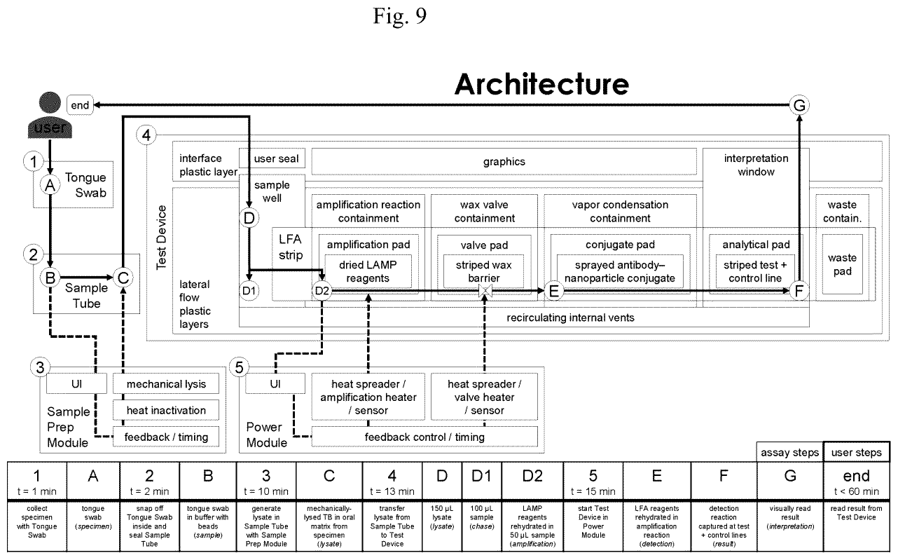

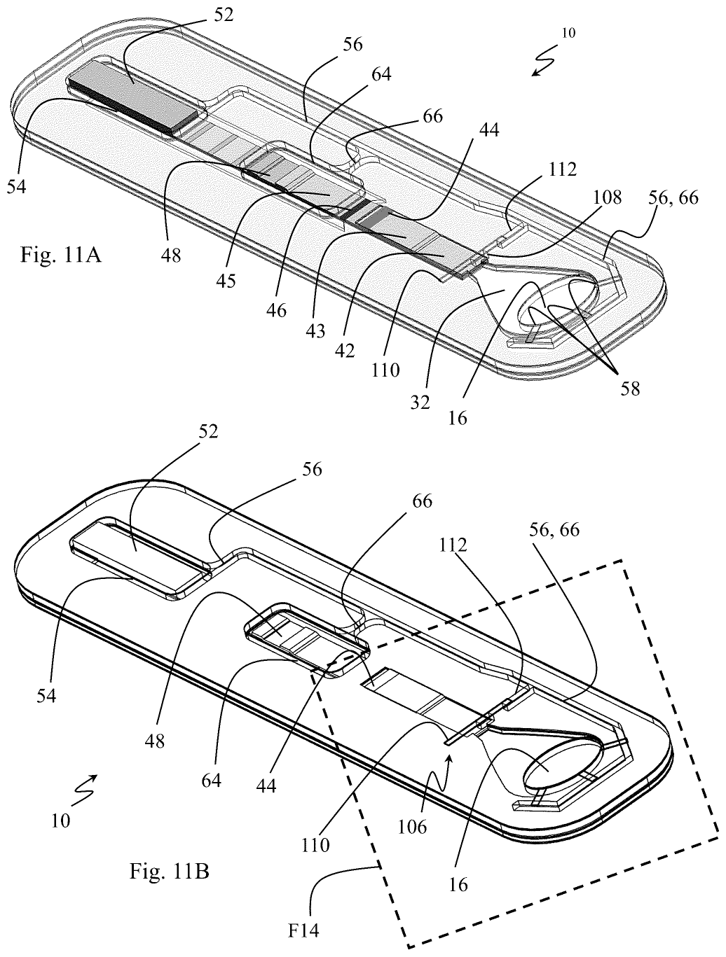

The architecture for the workflow process described in FIG. 8 is shown in FIG. 11. The assay and user steps of FIG. 9 are aligned with FIG. 8. Some elements of the device in FIG. 9 are referred to as alternate names compared to the description in paragraphs above. For example, the assay strip is referred to as the LFA strip; the amplification zone is referred to as the amplification reaction containment, with the wax valve containment occupying part of the amplification zone; the wax valve is referred to as the striped wax barrier; the reagent labeling pad is referred to as the conjugate pad; the detection zone is referred to as the vapor condensation containment, with the wax valve containment occupying part of the detection zone; the detection pad is referred to as the analytical pad; the read window is referred to as the interpretation window; the wick pad is referred to as the waste pad; and the sample port is referred to as the sample well.

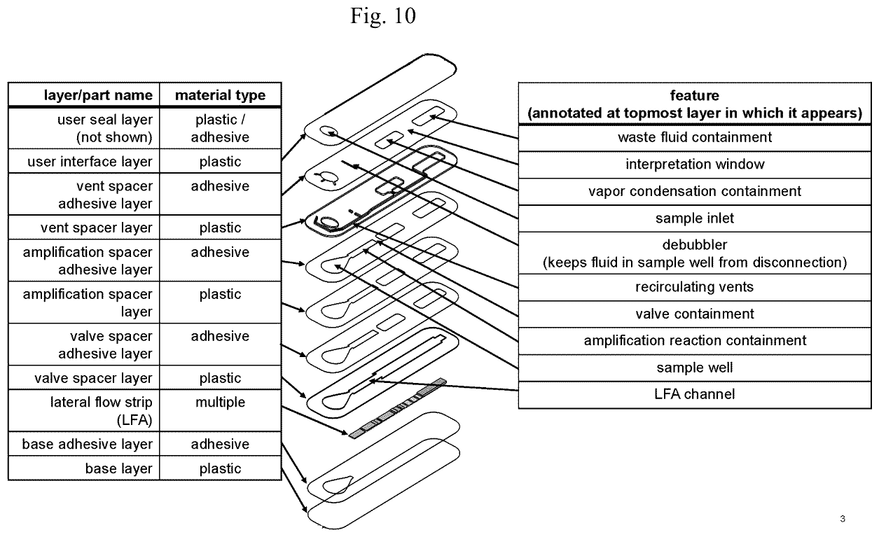

Turning to FIG. 10, an exploded view of the laminate testing device 10 of FIG. 8 is shown. Each layer or part is named in the far-left column, with an arrow indicating the respective part or layer. In the middle column, an example of a material type for each respective layer is listed. In the far-right column features are named and then indicated with arrows pointing to the topmost layer in which the feature appears. The upper seal level is not shown for clarity.

Turning now to FIGS. 11A and 11B, the testing device of the embodiment of FIG. 8 is shown in more detail. Again, the upper seal level is not shown for clarity. FIG. 11A is partially see-through, with the assay strip showing through the top six layers of this embodiment, not counting the seal layer. The first and second venting channels are clearly seen leaving the respective first and second venting inlets, and joining as they progress upstream vertically above and to the right of the flow path, as viewed in the drawing. At a location upstream of the valve to where the sample distributor pad begins, one or more debubblers 106 are preferably located. Continuing upstream, the first and second venting channels curve around the front of the inlet port and connect to the inlet port from above with three separate vent outlets 58, 68. The inventors experimented and discovered that with the three vent outlet paths 56, 58 at the port end 30 of the sample port 16 sample well when the user loads the sample, one or two vent outlet paths 56, 66 might be blocked, but the likelihood of all three of the vent outlet paths 56, 66 being blocked is much lower. Therefore, the mitigation of the number and location of the vent outlet paths 56 and 66 aids in avoiding a totality of blocked air vents, which would cause decreased fluidic performance. The air in the testing device 10 is preferably allowed to recirculate from downstream of the wax valve 45 to upstream of substantially all the fluid, which is maximized in this embodiment by the three vent outlets 58, 68 far upstream of the sample preparation zone 24.

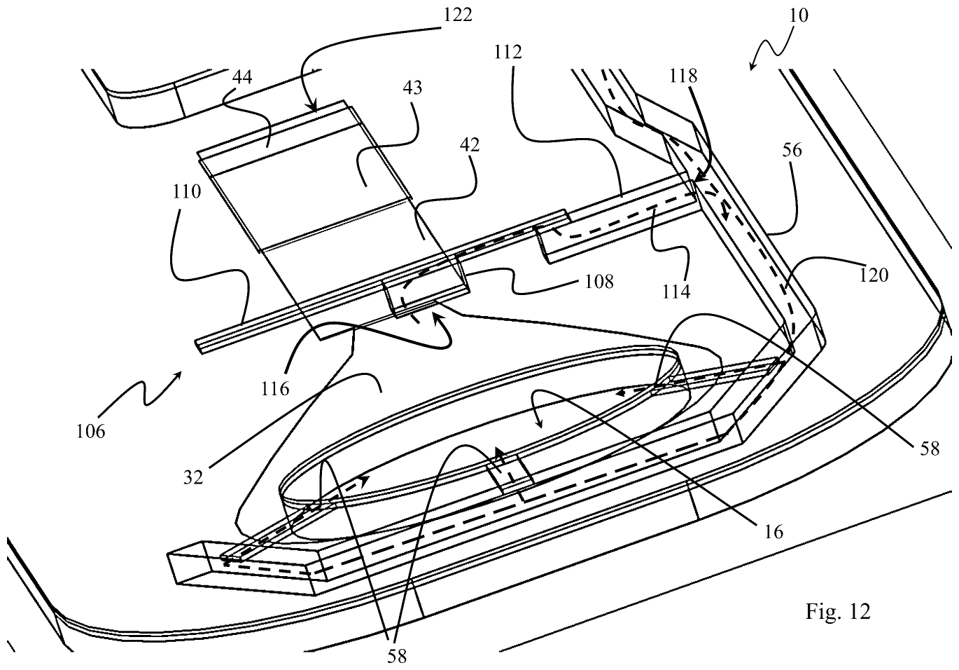

Turning to FIG. 12, the debubbler 106 is shown in greater detail. As shown, the debubbler 106 includes a debubbler inlet 108, an apex bridge 110, and a debubbler outlet 112. The debubbler outlet 112 in the embodiment shown fluidly connects to the first and second venting channel 56, 66. In other embodiments, the debubbler outlet 112 may directly connect to the inlet port 16, preferably adjacent to the port end 30 of the testing device 10, without connecting to the first and/or second venting channel 56, 66. The debubbler 106 provides a debubbler path 114 for air/gas to progress from the debubbler inlet mouth 116, through the debubbler 106, to escape out the debubbler outlet mouth 118 to relieve pressure and allow liquid to progress downstream along the fluid path 62 toward the valve 45. In the embodiment shown, the debubbler path 114 joins up with the venting path 120 of the first and second internal vents 18, 20. The debubbler 106 also provides space in the apex bridge 110 to accept bubbles that form in the added sample.

The debubbler 106 was created by the inventors to ensure a fluidic connection between the sample well at the input port 16 and the upstream end of the sample distributor pad 42, a porous material. The inventors found that in some cases bubbles could disconnect the sample chamber fluid from the fluid in the assay strip 22, which could restrict fluidic transport and stall the fluid front downstream in the assay strip 22, causing a testing device 10 failure, because the test and control lines 51, 56 would not form or would be obscured by the fluid front. The inventors discovered that by fluidically pairing the debubbler 106 with the outlet vents 58, 68, as shown, the backflow of fluid into the vents 58, 68 is minimized. This is an advantage, as fluidic blockage dramatically reduces the functionality of the vents 58, 68.

In the embodiment shown, the debubbler inlet 108 splits the transition between two zones and only covers half of the width of the fluid path 62. The half-path-width feature aids in minimizing fluid moving into the debubbler inlet 108. Further, in the layered embodiment shown, the debubbler inlet 108 is on an asymmetrical layer (the vent spacer layer, FIG. 10), so it is beneficial to minimize assembly issues to have an asymmetrical feature in the layer shown. The apex bridge 110, however, is closed on one end and is tied into the debubbler inlet 108 and debubbler outlet 112 on another end. While the apex bridge 110 may function as well with substantially only the portion that overlaps the dubber inlet 108 and debubbler outlet 112 being present, the apex bridge 110 is on an otherwise symmetrical layer (the vent spacer adhesive layer, FIG. 10), so making this feature symmetrical leads to fewer mistakes in assembly.

The debubbler path 114 allows bubbles that might disconnect the incoming fluid between the open chamber sample port 16 and the porous material at the upstream end of the assay strip 22 to go up and out to the debubbler 106 recirculating vent. The debubbler 106 is transferred through the thicker layer, where the debubbler inlet 108 and debubbler outlet 112 are located, into the thinner layer above, where the apex bridge 110 is located, to discourage liquid from leaking into the debubbler 106 recirculating vent. In a further embodiment, a hydrophobic treatment or filter could be incorporated in the debubbler 106, which would allow for a single-layer path from debubbler inlet 108 to debubbler outlet 112.

It was determined that venting in or around the assay strip 22 upstream of the valve 45 is especially beneficial to ensuring the amplification pad rehydrates fully with the sample fluid and aids the entire volume of sample fluid in staying connected so that the assay strip 22 operates correctly (via capillary action). This is particularly true after valve 45 actuation, as flow can stall with an insufficient supply of fluid on the assay strip 22 upstream of the valve 45. The inventors discovered this is so because the pressure in the porous materials that oppose capillary action increases as saturation drops, and that high saturation leads to the fastest capillary flow.

Upon further experimentation, the inventors discovered that the debubbler 106 effectively functioned in other locations between the placement shown in FIGS. 11A and 11B and just upstream of the valve 45, just a vent. The debubbler 106 was found to perform well when the debubbler outlet 112 is arranged to release air that might cause a fluidic disconnection, in a manner allowing that air to recirculate back as well. Though the debubbler 106 occasioned the formation of bubbles at the air/paper (assay strip 22) interface as shown in FIGS. 11A and 11B, when the debubbler 106 was moved to a downstream location 122, just upstream of the wax valve 45, the inventors found that at this position the debubbler 106 let out the air as the assay strip 22 filled, and functioned just as well as at the upstream location at the air/paper interface. Upon further experimentation, it was found that the downstream debubbler location 122 is preferred as it ensures complete filling of the amplification pad 44 and, therefore, rehydration of the dry reagents stored in the amplification pad 44 and appears to mitigate bubbles at the chamber/strip interface through that downstream venting all the same.

In further embodiments, such as with particularly viscous or otherwise fluidically complicated samples, two or more debubblers 106 may be provided. In such an embodiment, one debubbler 106 may be positioned at the air/paper interface shown in FIGS. 11A and 11B, and a second debubbler 106 may be positioned in the downstream debubbler location 122, for example.

The invention illustratively disclosed herein suitably may explicitly be practiced in the absence of any element that is not specifically disclosed herein. While various embodiments of the present invention have been described in detail, it is apparent that various modifications and alterations of those embodiments will occur to and be readily apparent those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. The present disclosure also contemplates other embodiments “comprising,” “consisting of” and “consisting essentially of,” the embodiments or elements presented herein, whether explicitly set forth or not. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items, while only the terms “consisting of” and “consisting only of” are to be construed in the limitative sense.

Wherefore, I/we claim:

1. A testing device comprising:
a fluid management layer including
a fluid management body;
a sample port defined in the fluid management body;
an assay strip encased in the fluid management body along a fluid path;
a valve defined on the assay strip; and
a first internal vent having a first vent inlet, a first vent outlet, and a first venting channel connecting the first vent inlet to the first vent outlet;
wherein the first vent inlet is arranged at a first location in the fluid management body along the fluid path downstream of the valve, and the first vent outlet is at a second location in the fluid management body upstream of the valve.

2. The testing device of claim 1, further comprising a second internal vent including a second vent inlet, a second vent outlet, and a second venting channel connecting the first vent inlet to the first vent outlet, wherein the second vent inlet is arranged at a third location in the fluid management body along the fluid path downstream of the valve and upstream of the first vent inlet, and the second vent outlet is at a fourth location in the fluid management body upstream of the valve.

3. The testing device of claim 2, wherein the assay strip contains a nucleic acid amplification pad on an amplification side of the valve, and both a reagent labeling pad and a detection pad are on a detection side of the valve.

4. The testing device of claim 3, wherein the assay strip further comprises a sample distributor pad spaced from the valve by the amplification pad and a wick pad spaced from the valve by the reagent labeling pad and the detection pad.

5. The testing device of claim 4, wherein the second venting channel fluidically merges with the first venting channel, the second location is also the fourth location, and the second vent outlet is defined by the first vent outlet.

6. The testing device of claim 5, wherein three first vent outlets are defined in the fluid management body, fluidically connected to the first venting channel.

7. The testing device of claim 6, further comprising a debubbler with a debubbler inlet fluidly connected to a debubbler outlet along a debubbler path, where the debubbler inlet is arranged at a fifth location in the fluid management body along the fluid path upstream of the valve and downstream of the sample port, and the debubbler outlet is downstream the debubbler path from the debubbler inlet, where the debubbler path is fluidly connected to the sample port.

8. The testing device of claim 7, wherein the debubbler inlet is fluidly connected to the debubbler outlet by an apex bridge, where the apex bridge is vertically spaced further from the assay strip than the debubbler inlet and/or the debubbler outlet.

9. The testing device of claim 7, wherein the debubbler outlet is fluidly connected to the first venting channel.

10. The testing device of claim 4, wherein the sample distributor pad overlaps a majority but not all of the application pad at a distributor/application overlap.

11. The testing device of claim 4, wherein the valve is one of a wax strip valve, a dissolving valve, an electrically stimulated hydrophobic valve, and a thermally stimulated hydrophobic valve.

12. The testing device of claim 4 further comprising a heating layer adjacent to the fluid management layer.

13. The testing device of claim 12, wherein the heating layer comprises one of an amplification heater, a valve heater, and both an amplification heater and a valve heater.

14. The testing device of claim 13, further comprising a heat spreader spacing the one or more heaters from the fluid management layer.

15. The testing device of claim 14, further comprising a battery layer functionally connected to the one or more heaters of the heating layer.

16. The testing device of claim 1 wherein the testing device comprises a number of laminate layers, where the number is between 3 and 12.

17. The testing device of claim 9, wherein
the amplification pad is made from one or more porous materials, is blocked with reagents to keep a nucleic acid amplification reaction from sticking to the one or more porous materials, and is impregnated with loop-mediated isothermal amplification reagents mixed with excipients and then lyophilized;
the reagent labeling pad is made from one or more porous materials, and is blocked and sprayed with one or more of conjugates, anti-FITC antibodies, and affinity reagents specific to small molecules and that are attachable to an oligonucleotide; and
the detection pad is made from porous nitrocellulose and has one or more test lines to capture labeled amplicons and one or more control lines to capture one or more internal positive control products and free conjugates.

18. A kit comprising:
a testing device comprising
a fluid management layer having
a fluid management body;
a sample port defined in the fluid management body;
an assay strip encased in the fluid management body along a fluid path;
a valve defined on the assay strip, with the assay strip containing a nucleic acid amplification pad on an amplification side of the valve, and both a reagent labeling pad and a detection pad on a detection side of the valve; and
a first internal vent having a first vent inlet, a first vent outlet, and a first venting channel connecting the first vent inlet to the first vent outlet wherein the first vent inlet is arranged at a first location in the fluid management body along the fluid path downstream of the valve, and the first vent outlet is at a second location in the fluid management body upstream of the valve; and
a seal layer sealing the fluid management layer; and
a dropper tube with liquid reagents stored within; and
a swab.

19. A system comprising:
a testing device comprising
a fluid management layer having
a fluid management body;
a sample port defined in the fluid management body;
an assay strip encased in the fluid management body along a fluid path;
a valve defined on the assay strip, with the assay strip containing a nucleic acid amplification pad on an amplification side of the valve, and both a reagent labeling pad and a detection pad on a detection side of the valve; and
a first internal vent having a first vent inlet, a first vent outlet, and a first venting channel connecting the first vent inlet to the first vent outlet wherein the first vent inlet is arranged at a first location in the fluid management body along the fluid path downstream of the valve, and the first vent outlet is at a second location in the fluid management body upstream of the valve; and
a seal layer sealing the fluid management layer; and
a dropper tube with liquid reagents stored within;
a swab;
a standalone sample preparation module; and
a standalone power module for heating the testing device to an appropriate temperature for amplification.

20. The system of claim 19, wherein the power module also actuates the valve at a point in time after the amplification is started.
